(19) United States
(12) Patent Application Publication
(10) Pub. No.: US 2007/0129983 A1
(43) Pub. Date: Jun. 7, 2007

(54) Task and Workflow Management System for Healthcare and other Applications

(75) Inventors: Harm Jacob Scherpbier, Fort Washington, PA (US); John Weis, Collegeville, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS HEALTH SERVICES CORPORATION, MALVERN, PA (US)

(21) Appl. No.: 11/549,253

(22) Filed: Oct. 13, 2006

Related U.S. Application Data
(60) Provisional application No. 60/741,338, filed on Dec. 1, 2005.

(51) Int. Cl. G05B 19/418

(52) U.S. Cl. 705/8

(57) ABSTRACT

A task management system uses patient tags (e.g., wireless RFID, Infrared tracking, GPS etc.) for patient location tracking, together with an integrated workflow system to automatically, track patient location how long they have been there and how many patients are at the same location (e.g., waiting room) and manages waiting time and an overall waiting queue, supporting automated adjustment of healthcare staffing, patient flows, and team coordination. A task management system for use in providing healthcare to a patient includes a patient tracking processor and a workflow processor. The patient tracking processor automatically acquires data derived by wireless communication from patient attached tag devices for use in identifying a location of multiple patients in a healthcare enterprise and identifying a first number of patients at a particular location and a second number of patients awaiting receiving a particular type of treatment. The workflow processor automatically initiates a patient load balancing activity to improve a match between a healthcare resource and a patient load by communicating a message to update a healthcare worker task schedule with a task in response to a determination the identified first or second number of patients exceeds a predetermined threshold number.

### CROSS-REFERENCE TO RELATED APPLICATIONS

The present application is a non-provisional application of provisional application having Ser. No. 60/741,338 by H. J. Scherpbier on Dec. 1, 2005.

### FIELD OF THE INVENTION

The present invention concerns a task management system for use in providing healthcare to a patient involving automatically tracking patients at different locations and automatic patient load balancing in healthcare resource management.

### BACKGROUND OF THE INVENTION

In existing healthcare enterprises, Hospital Emergency Departments (EDs) need efficient patient flow management and flexible resource capacity management to handle fluctuating demand for emergency care. An ED is a high-throughput area in most hospitals and in many cases account for a substantial proportion (e.g., over fifty percent) of hospital admissions. In an ED, two patient management bottlenecks include, (i) from a waiting area to being seen in an ED, due to lack of ED staff capacity and inefficient use of resources and (ii) from an ED into a hospital, due to lack of available beds. Existing systems address this problem using systems for Manual Patient Tracking in which ED staff manually track patient location and status through a paper-based system and/or an ED display board showing manually acquired resource tracking data. Existing systems also address this problem by tracking patients using RFID (Radio Frequency ID), Barcode, or Infrared (IR) tags. However Manual patient tracking requires manual information update by ED staf and is labor intensive and error prone. Also some automated patient tracking systems (e.g., using barcodes, some forms of RFID) require manual action by ED staff, and are also labor intensive and error prone.

Existing systems fail to provide a comprehensive automated patient tracking and resource management system integrated with a workflow management system for adaptively adjusting patient flow in a hospital, for example. A system according to invention principles addresses these deficiencies and related problems.

### SUMMARY OF THE INVENTION

A task management system uses patient tags (e.g., wireless RFID), Infrared tracking, GPS etc.) for patient location tracking together with an integrated workflow system to automatically manage and adapt worker tasks (e.g., automatic opening or closing extra beds or employing extra staff) and to balance patient load and flow in a hospital. A task management system for use in providing healthcare to a patient includes a patient tracking processor and a workflow processor. The patient tracking processor automatically acquires data derived by wireless communication from patient attached tag devices for use in, identifying a location of multiple patients in a healthcare enterprise and identifying a first number of patients at a particular location and a second number of patients awaiting, receiving a particular type of treatment. The workflow processor automatically initiates a patient load balancing activity to improve a match between a healthcare resource and a patient load by communicating a message to update a healthcare worker task schedule with a task in response to a determination the identified first or second number of patients exceeds a predetermined threshold number.

### BRIEF DESCRIPTION OF THE DRAWINGS

FIG. 1 shows a task management system for use in a Hospital, for example, using RFID/IR patient Tracking and a Workflow processor, in accordance with invention principles.

FIG. 2 shows an adaptively configurable workflow process employed by the task management system of FIG. 1, in accordance with invention principles.

FIG. 3 shows a task management process employed by the system of FIG. 1, in accordance with invention principles.

### DETAIL DESCRIPTION OF THE INVENTION

A task management system for use in a Hospital, for example, uses RFID/IR patient Tracking and a Workflow processor system to track where a patient is, how long they have been there, and how many patients are at the same location (e.g., in a waiting room), The system is applicable for hospital emergency department or other department settings or an office setting to advantageously manage patient waiting time and an overall waiting queue, support automated adjustment of (e.g., ED) staffing, patient flows, and team coordination. The task management system automatically manages and adapts scheduled worker tasks (e.g., for automatic opening or closing extra beds or employing extra staff) and balance patient load and flow in a hospital. The system automates patient flow through an Emergency Department (ED) of a hospital, for example and from the ED into the hospital for patients who are admitted and reduces patient management bottlenecks. This is achieved through better workflow management, prioritization, task management and assignment, escalation of delays, coordination of subsequent tasks and ED team management. The system employs a Workflow Management System (workflow processor) using tracking functions in updating patient location and automated adjustment of ED staffing, patient flows, team coordination and is responsive to the number of patients in each processing stage in an ED.

The use of automatic RFID/IR patient Tracking enables a Workflow processor to track patient location and duration of patient stay in each hospital area without requiring human input or data entry. The RFID/IR patient Tracking function combined with a Workflow processor enables the system to know where individual patients are, the duration of individual patient stay at a location and the number of patients at a location or processing stage. This enables management of staffing and processes in an ED to avoid patient treatment bottlenecks and maximize patient throughput. The system advantageously provides an automatic passive patient tracking function and eliminates a need for ED staff to physically enter data indicating patient location to track patient movement. The patient tracking information is employed by a workflow processor in ED departments and hospitals to automatically detect patient bottlenecks and automatically initiate actions in response to detected bottlenecks to increase resources and operational capacity without human intervention based on predetermined business process rules.

Although existing known systems employ RFD patient location tracking and use this capability to affect patient flow, existing systems do not employ a patient location tracking function integrated with a workflow engine to automatically adjust patient flow and provide patient load balancing through automatically opening or closing extra beds or employing extra staff etc. The existing systems also do not automatically monitor overall patient load in a system (department or facility) by comprehensively tracking patients and their individual duration of stay in particular locations and how many there are in particular locations, and use this information to adjust patient flow through an ED.

An executable application as used herein comprises code or machine readable instruction for implementing predetermined functions including those of an operating system, healthcare information system or other information processing system, for example, in response to user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device. Workflow comprises a sequence of tasks performed by device or personnel or a combination of both

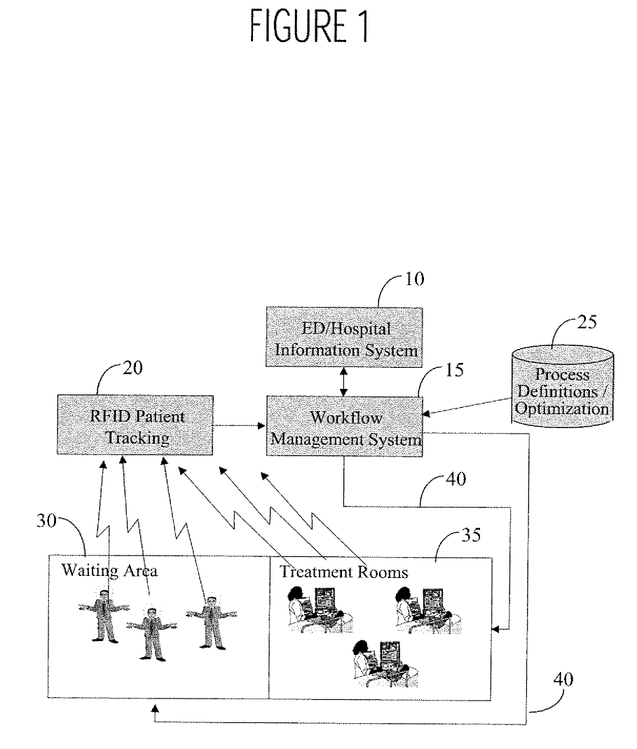

FIG. 1 shows task management system 100 for use in a Hospital, for example, using RFID/IR patient Tracking and a Workflow processor. System 100 includes an ED/HIS (Hospital Information System) 10, Workflow processor 15. RFID tracking processor 20, a repository of information determining processes and optimization methods 25, patient waiting area 30 and treatment rooms 35. ED/HIS 10 may comprise comprehensive Hospital Information System functions including patient registration, and management of patient clinical and financial data. The elements 10, 15, 20, 25 of system 100 inter-communicate via one or more wired and/or wireless networks 40. Tracking processor 20 tracks and monitors location of patients, equipment, supplies and healthcare workers using RFID tags attached to devices and personnel in waiting area 30, treatment rooms 35 and elsewhere. Patient tracking processor 20 automatically, acquires data derived by wireless communication from patient attached tag devices for use in identifying a location of multiple patients, e.g., in waiting area 30 in a healthcare enterprise. Patient tracking processor 20 automatically, identifies a first number of patients at a particular location, e.g., waiting area 30 and a second number of patients awaiting receiving a particular type of treatment, e.g., in treatment rooms 35. Workflow processor 15 automatically initiates a patient load balancing activity to improve a match between a healthcare resource, e.g. in a treatment room of rooms 35 and a patient load (e.g., patients in waiting area 30, by communicating a message to update a healthcare worker task schedule with a task in response to a determination the identified first or second number of patients exceeds a predetermined threshold number.

Workflow processor 15 allows ED (and other hospital departments) to automatically manage processes and optimize patient flow through the department. Workflow processor 15 manages tasks for ED staff, assigns and delegates tasks, prioritizes tasks based on pre-set parameters, coordinates subsequent tasks and also escalates alerts to successive levels of supervisory personnel if a task is not executed on time. Further, workflow processor 15 allocates additional staff and alternative resources in response to demand and manages an ED team of healthcare workers. Also, workflow processor 15 allows individual departments to define their processes and continuously optimize them. RFID tracking processor 20 acquires RFID location tracking information from RFID/IR readers installed at locations in an ED (and/or other hospital departments) that detect RFIE (or IR) tags incorporated on patient wristbands, for example, and attached to healthcare workers and equipment and supplies. The RFID/IR readers detect RFID (or IR) tags in their vicinity and uses the location information derived based on the known location of the RFID/IR readers to track patients, equipment and supplies. The location information is provided to workflow processor 15 which uses this information to measure how long an individual patient is in a particular location, how many patients are in each location and processing stage and how to adjust staffing, processes and patient prioritization to optimize patient flow and avoid bottlenecks.

In operation, as patients arrive in an ED, they receive a name label combined with a RFID tag or IR tag. Tracking processor 20, in system 100, initiates identifying patient presence in hospital departments and their movement and location. RFID/IR readers employed by tracking processor 20 detect the RFID (or IR) patient tags and determine a number of patients in waiting area 30 and the average waiting period for each patient. Workflow processor 15 uses data from tracking processor 20 to determine if the number of patients in waiting area 30 exceeds a predetermined threshold, for example 10, and determine if an average patient wait duration exceeds 30 minutes, and if a longest patient wait duration exceeds 1 hour. In response to these determinations, workflow processor 15 performs at least one of multiple different actions. The different actions include, for example, notifying a department or supervisory manager to deploy additional physicians and nurses, open up an additional section of the ED to handle minor cases thereby allowing the main section of the ED to focus on relevant injuries and medical emergencies and additional actions as predetermined by the ED or another department

Workflow processor 15 uses RFID or IR derived tracking data, received from tracking processor 20, to detect how many patients are in beds in the ED and being, seen by doctors and nurses as well as waiting for imaging studies and laboratory tests to be performed. Further, some of the tracked patients are indicated as waiting for admission to the ED or another hospital facility. Workflow processor 15 uses tracking data to track how many patients are waiting for admission and how long on average, individual patients have been waiting. Workflow processor 15 also determines if the number of patients waiting for admission exceeds a threshold, or the average wait time exceeds a predetermined threshold and in response to tracking findings and determinations, processor 15 automatically initiates actions to reduce patient processing bottlenecks. Specifically, workflow processor 15 initiates a process to speed up discharges and increase bed availability if there are no beds available to accommodate transferred patients. Workflow processor 15 automatically notifies a staffing allocation function that there are beds available and that there are no staff (e.g., doctors, nurses) to perform patient transfers and processor 15 automatically assigns patient admissions from other areas to the ED. Processor 15 performs other methods to reduce patient processing bottlenecks in response to predetermined hospital instruction.

System 100 is used in a hospital emergency department, clinic or office setting (and any setting in which people have to wait for service) to manage workflow, System 100 allows a Hospital ED department to determine the flow of patients through the department and adjust the flow based on circumstances using predetermined process rules. For example, workflow processor 15, using data provided by tracking processor 20, detects if an average patient wait time to receive a service exceeds ninety minutes, or if the number of patients in a waiting area exceeds twenty and updates healthcare worker and device task lists to initiate opening up of an additional series of ED beds and deploy additional ED staff. Workflow processor 15 operating in conjunction with tracking processor 20, tracks patients by type of diagnosis (e.g., medical condition, procedure code, diagnostic code and triaged diagnosis). Thereby, workflow processor 15 automatically determines the number of blunt-traumatic injuries in a hospital may require more orthopedic doctors, while the number of high fevers may require more internists. Workflow processor 15 automatically notifies the required physicians and/or schedules them for attendance in operating rooms or other treatment areas.

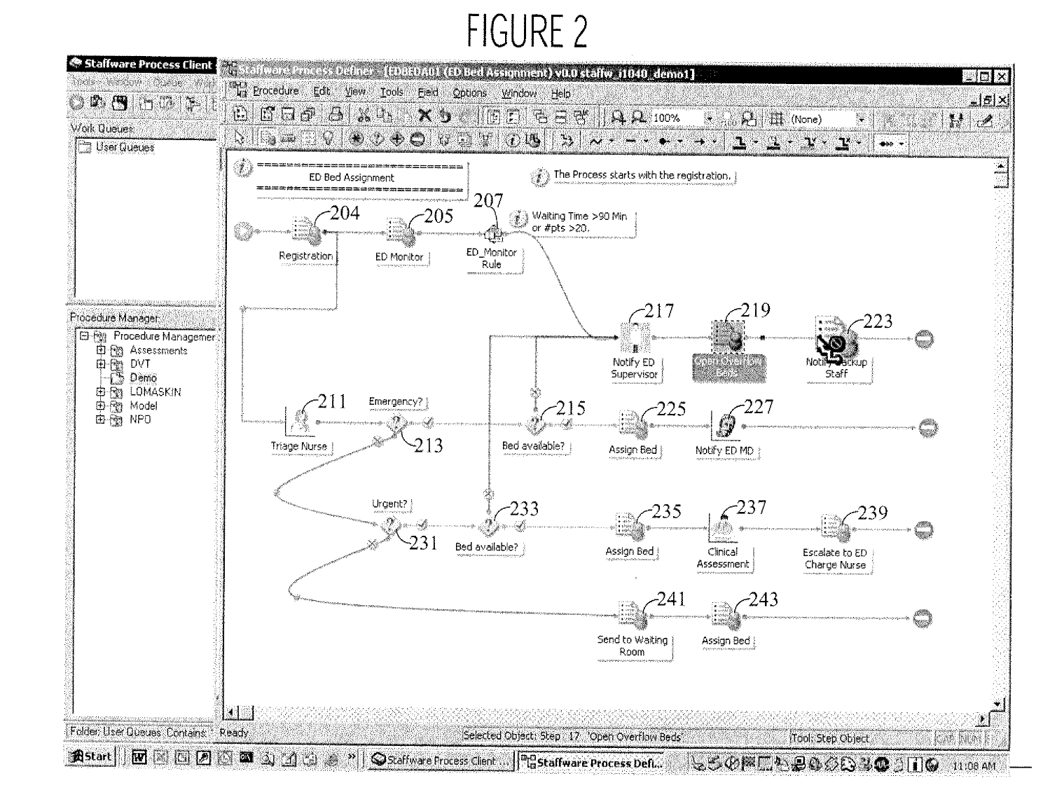

FIG. 2 shows an adaptively configurable workflow process employed by the task management system 100 of FIG. 1. The workflow process is configurable and adaptable to meet the requirements of an individual hospital and is continuously adapted to adjust and improve the process. In known systems a user needs to enter data to a workflow system indicating how many patients there are in locations concerned, when the patients arrived at the locations and how long the patients have been waiting. In system 100, in contrast, tracking processor 20 (FIG. 1) detects RFID tags to identify patients and their location in an ED and enables system 100 to track patient location, how long a patient has been in a particular location or stage in treatment process, how many patients are at a particular location or treatment process stage. System 100, based on instruction incorporating predetermined rules, automatically initiates actions by devices and healthcare workers by incorporating tasks for performance by the devices and workers on respective scheduled task lists, for example, in response to detection of different conditions. The different conditions comprise, for example, too many patients being at a particular treatment processing stage, an average patient turn-around time exceeds a pre-set limit and an individual patient wait time exceeds a predetermined threshold.

In the process of FIG. 2, following patient registration in step 204, system 100 in step 205 monitors ED patient status and in step 207 applies predetermined rules. Specifically, workflow processor 15 (FIG. 1) analyzes received patient tracking data derived by tracking processor 20 to determine if various conditions have occurred The various conditions comprise, for example, whether, average patient wait time exceeds ninety minutes, a number of patients in a waiting area or treatment processing stage exceeds twenty or a bed for an emergency or urgent care case is unavailable. In response to workflow processor 15 determining one or more of the various conditions has occurred, processor 15 performs multiple different actions including, for example, notifying a department or supervisory manager in step 217 to open up additional overflow beds in step 219 and notify and deploy additional physicians and nurses in step 223. Processor 15 notifies an ED Supervisor or other personnel of conditions via a worklist within a clinical or ED information system or via pager, email or telephone or voice response system, for example. Other different conditions may also cause processor 15 to notify an ED supervisor of a condition and cause processor 15 to automatically initiate actions other than notifying an ED supervisor. For example, in response to patient load exceeding a predetermined threshold (e.g., waiting patients for a particular service exceeding twenty), workflow processor 15 automatically updates a city-wide or region-wide monitoring system causing ambulances to divert patients elsewhere. Similarly, processor 15 updates the city-wide or region-wide monitoring system to indicate load is low, or manageable, and patients are being accepted at a particular ED. Further, processor 15 expedites discharging hospital patients to create bed-availability for ED patients and automatically initiates opening of an additional unit in a non-ED area of a hospital so that ED patients may be admitted to this area and create space in the ED. In addition, processor 15 automatically performs other hospital-based actions to adjust ED capacity upward or downward.

In response to data indicating occurrence of a nurse triage examination in step 211 and determination a patient condition is an emergency in step 213, system 100 automatically determines a bed is available in an ED in step 215 and assigns a bed to the emergency patient in step 225. System 100 notifies a physician of the emergency case in step 227. The previously performed steps 217, 219 and 223 ensure beds are available. Similarly, in response to data indicating occurrence of a nurse triage examination in step 211 and determination a patient condition is urgent in step 231, system 100 automatically determines a bed is available in an ED in step 233 and assigns a bed to the urgent patient in step 235. Further, in response to clinical assessment information acquired and entered by a user in step 237, system 100 escalates the case by notifying an ED supervisory nurse in step 239. The previously performed steps 217, 219 and 223 ensure beds are available In response to data indicating occurrence of a nurse triage examination in step 211 and determination a patient condition is a non-urgent case in step 231, system 100 automatically initiates sending the patient to a waiting room in step 241 and assigns a bed to the patient in step 243.

System 100 is used in a Hospital ED department (or other departments), to manage capacity and patient flow, and assess a patient load in the system including number of patients in particular locations, at particular stages, average and maximum duration of time of patients being in particular locations or at particular treatment stages without need for human inputs or updates. System 100 automatically employs RFID/IR (or other) patient location data by continuously adjusting the capacity of a hospital department, either upward or downward, to patient load. System 100 does this based on information determining processes and optimization methods in a repository 25 (FIG. 1). This information comprises sequences of configurable rules and steps that determine system 100 actions in response to patient volumes and loading. The rules and steps are configurable for a hospital, for example, to be specific to that hospital and to adjust processes over time.

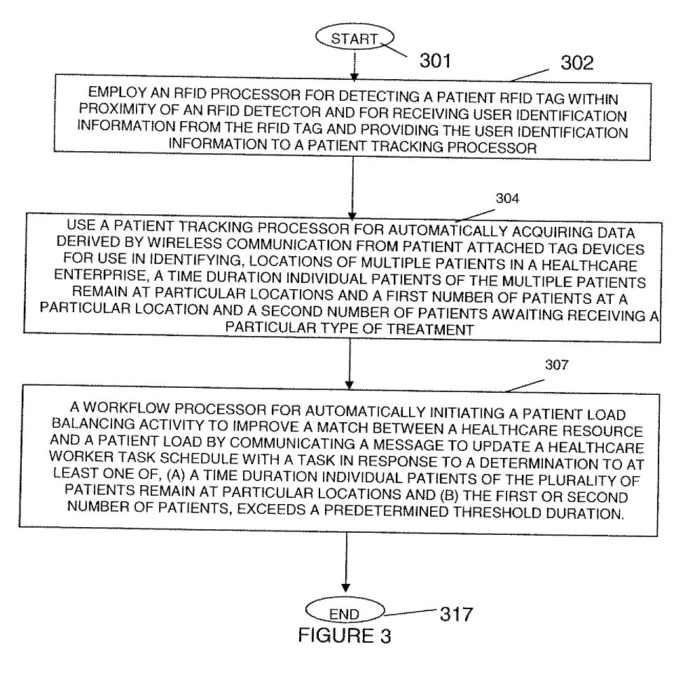

FIG. 3 shows a task management process employed by system 100 (FIG. 1). In step 302 following the start at step 301 an RFID processor detects a patient RFID tag within proximity of an RFID detector and receives user identification information from the RFID tag and provides the user identification information to patient tracking processor 20. Patient tracking processor 20 in step 304 automatically acquires data derived by wireless communication from patient attached tag devices. The acquired data is for use by processor 20 in identifying, locations of multiple patients in a healthcare enterprise, a time duration individual patients of the multiple patients remain at particular locations and a first number of patients at a particular location and a second number of patients awaiting receiving a particular type of treatment. Patient tracking processor 20 also automatically associates individual patients with at least one of, a particular type of treatment and a particular stage of treatment and automatically identifies at least one of, an average patient wait time for a particular treatment and bed unavailability. Patient tracking processor 20 further identifies, an average time duration multiple patients remain at a particular location and a maximum time duration an individual patient remains at a particular location. Also particular locations may comprise particular treatment processing stages.

In step 307, workflow processor 15 automatically initiates a patient load balancing activity to improve a match between a healthcare resource and a patient load by communicating a message to update a healthcare worker task schedule with a task. This is done in response to a determination of at least one of, (a) a time duration individual patients of the multiple patients remain at particular locations, (b) the first or second number of patients, exceeds a predetermined threshold duration and (c) the average patient wait time exceeds a predetermined threshold wait time. Workflow processor 15 automatically communicates the message to update a healthcare worker task schedule by worker worklist, pager, email or a phone/voice response system. System 10 provides a worklist, specific by role (nurse, physician, ED manager) and capacity related messages appear on the worklist of an ED manager, for example). Further, the patient load balancing activity comprises automatically adjusting patient flow, initiating opening or closing patient beds or initiating employing extra staff.

The patient load balancing activity comprises re-directing one or more of the first number of patients associated with a particular type of treatment or a particular stage of treatment to a location different than the particular location. In this case, the task on the healthcare worker task schedule prompts the healthcare worker to initiate the re-direction of the one or more of the first number of patients. The patient load balancing activity may also comprise expediting release of resources supporting healthcare delivery to one or more of the second number of patients. In this case the task on the healthcare worker task schedule prompts the healthcare worker to initiate expediting release of the resources comprising at least one of, expediting discharge of patients, expediting performance of a treatment activity for a patient to advance availability of a resource and expediting cleaning of a room or equipment. The patient load balancing activity may also comprise activating previously idle resources and the task on the healthcare worker task schedule prompts the healthcare worker to initiate this activation. The activation of previously idle resources comprises bringing in to service at least one of, hospital beds, medical equipment and healthcare workers.

The system and processes presented in FIGS. 1-3 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the arts without departing from the scope of the invention. A system according to invention principles is applicable anywhere for automatic task management in conjunction with automatic resource or personnel location tracking Further, any of the functions provided in the system of FIG. 1 may be implemented in hardware, software or a combination of both and may reside on one or more processing devices located at any location of a network linking the FIG. 1 elements or another linked network including another intra-net or the Internet.

What is claimed is:

1. A task management system for use in providing healthcare to a patient, comprising:
a patient tracking processor for automatically,
acquiring data derived by wireless communication from patient attached tag devices for use in identifying a location of a plurality of patients in a healthcare enterprise and
identifying a first number of patients at a particular location and a second number of patients awaiting receiving a particular type of treatment; and
a workflow processor for automatically initiating a patient load balancing activity to improve a match between a healthcare resource and a patient load by communicating a message to update a healthcare worker task schedule with a task in response to a determination said identified first or second number of patients exceeds a predetermined threshold number.

2. A system according to claim 1, wherein
said patient load balancing activity comprises re-directing one or more of said first number of patients to a location different than said particular location to receive a particular type of treatment and
said task on said healthcare worker task schedule prompts said healthcare worker to initiate said re-directing of said one or more of said first number of patients.

3. A system according to claim 1, wherein
said patient load balancing activity comprises expediting release of resources supporting healthcare delivery to one or more of said second number of patients and
said task on said healthcare worker task schedule prompts said healthcare worker to initiate said expediting release of said resources.

4. A system according to claim 3, wherein
said expediting release of resources comprises at least one of, (a) expediting discharge of patients, (b) expediting performance of a treatment activity for a patient to advance availability of a resource and (c) expediting cleaning of a room or equipment.

5. A system according to claim 1, wherein
said patient tracking processor automatically associates individual patients with at least one of, (a) a particular type of treatment and (b) a particular stage of treatment and
said patient load balancing activity comprises re-directing one or more of said first number of patients associated with said particular type of treatment or said particular stage of treatment to a location different than said particular location.

6. A system according to claim 1, wherein
said patient load balancing activity comprises activating previously idle resources and
said task on said healthcare worker task schedule prompts said healthcare worker to initiate said activation.

7. A system according to claim 1, wherein
said activation of previously idle resources comprises bringing in to service at least one of, (a) hospital beds, (b) medical equipment, (c) healthcare workers, (d) Emergency Department beds and (e) an Emergency Department treatment room.

8. A system according to claim 1, wherein
said workflow processor automatically communicates said message to update a healthcare worker task schedule by at least one of, (a) a pager, (b) email, (c) a phone/voice response system and (d) a worker worklist

9. A system according to claim 1, wherein
said patient tracking processor automatically identifies at least one of, (a) an average patient wait time for a particular treatment and (b) bed unavailability.

10. A system according to claim 9, wherein
said workflow processor automatically initiates said patient load balancing activity in response to a determination said average patient wait time exceeds a predetermined threshold wait time.

11. A system according to claim 1, including
an RFID processor for detecting a patient RFID tag within proximity of an RFID detector and for receiving user identification information from said RFID tag and providing said user identification information to said patient tracking processor.

12. A task management system for use in providing healthcare to a patient, comprising:
a patient tracking processor for automatically acquiring data derived by wireless communication from patient attached tag devices for use in identifying,
locations of a plurality of patients in a healthcare enterprise and
a time duration individual patients of said plurality of patients remain at particular locations; and
a workflow processor for automatically initiating a patient load balancing activity to improve a match between a healthcare resource and a patient load by communicating a message to update a healthcare worker task schedule with a task in response to a determination time duration individual patients of said plurality of patients remain at particular locations exceeds a predetermined threshold duration.

13. A system according to claim 12, wherein
said patient tracking processor identifies a first number of patients at a particular location and a second number of patients awaiting receiving a particular type of treatment and
said workflow processor automatically initiates said patient load balancing activity in response to a determination said identified first or second number of patients exceeds a predetermined threshold number.

14. A system according to claim 12, wherein
said patient tracking processor identifies at least one of, (a) an average time duration a plurality of patients remain at a particular location and (b) a maximum time duration an individual patient remains at a particular location.

15. A system according to claim 12, wherein
particular locations comprise particular treatment processing stages.

16. A task management system for use in providing healthcare to a patient, comprising:
a patient tracking processor for automatically acquiring data derived by wireless communication from. patient attached tag, devices for use in identifying,
locations of a plurality of patients in a healthcare enterprise,
a time duration individual patients of said plurality of patients remain at particular locations and
a first number of patients at a particular location and a second number of patients awaiting receiving a particular type of treatment; and
a workflow processor for automatically initiating a patient load balancing activity to improve a match between a healthcare resource and a patient load by communicating a message to update a healthcare worker task schedule with a task in response to a determination of at least one of, (a) a time duration individual patients of said plurality of patients remain at particular locations and (b) said first or second number of patients, exceeds a predetermined threshold duration.

17. A system according to claim 16, wherein
said patient load balancing activity comprises automatically adjusting patient flow.

18. A system according to claim 16, wherein
said patient load balancing activity comprises automatically initiating opening or closing patient beds.

19. A system according to claim 16, wherein
said patient load balancing activity comprises automatically initiating employing extra staff.
